(19) United States
(12) Patent Application Publication
(10) Pub. No.: US 2005/0173037 A1
(43) Pub. Date: Aug. 11, 2005

(54) Method and unit for mounting on a rim a tire provided with a safety support

(75) Inventors: Jean-Louis Bocquet, Combronde (FR); Jean-Pierre Dumon, Saint-Doulchard (FR)

Correspondence Address: BURNS DOANE SWECKER & MATHIS L L P, POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/007,367

(22) Filed: Dec. 9, 2004

Related U.S. Application Data
(63) Continuation of application No. PCT/EP03/04315, filed on Apr. 25, 2003.

(30) Foreign Application Priority Data
Jun. 10, 2002 (FR) 02/07076

(51) Int. Cl. B60C 15/02

(52) U.S. Cl. 152/379.3

(57) ABSTRACT

The present invention concerns in particular a process for mounting onto a wheel rim (10), on the one hand a tyre (600) comprising first and second beads (620, 610) respectively designed to be mounted on a first and a second rim seat (13′, 13″), and on the other hand a safety support designed to be mounted inside the tyre on a bearing surface of the rim. This process comprises the following successive stages:
(a) the tyre provided with the support in its inside space is brought to the rim, offering the second bead (610) on the side of the first seat (13″), (b) the second bead is slipped over the bearing surface so as to introduce it into a mounting groove and the support is positioned partially in place on the bearing surface, the first bead then being located axially outside the first seat, (c) the support is fitted fully onto the bearing surface, (d) the first bead (620) is mounted on the first seat,
(e) the second bead is extracted from the groove so that it can be brought axially outside a projection of the second seat (13″), (f) the second bead is mounted on the second seat.

According to the invention, before implementing stage (b) a mean (510) for extracting the second bead in positioned at the bottom of the groove and, to implement stage (e), the second bead is guided axially towards the outside of the groove and the second seat by pivoting the extraction means around an axis (512) located radially on the inside of the rim.

The present invention concerns a process for mounting a tyre on a wheel rim and a safety support designed to support the tyre in the event of a fall in its inflation pressure, as well as a mounting unit for implementing the said process.

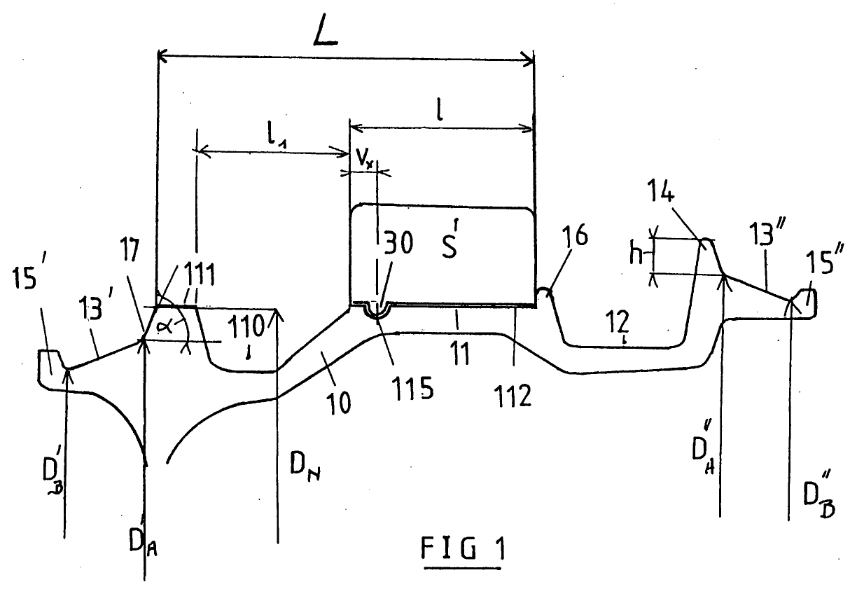

In relation to FIG. 1 below, it is known to use as a wheel rim included with the said support in a mounted assembly designed to be able to roll in satisfactory conditions when the inflation pressure is low or zero, a rim 10 at least one of whose seats is inclined axially towards the outside as viewed in meridian cross-section. This rim 10 is for example described in the international patent specification WO-A-01/08905, and can form a wheel with a disc that can be manufactured independently of the rim 10 and then attached thereto.

The rim 10 of FIG. 1 comprises two frustoconical rim seats 13′ and 13″ with unequal respective diameters D′_{A} and D″_{A}. The diameter of a frustoconical seat is understood to be the diameter of its largest circular edge.

The generatrices of the two seats 13′ and 13″ are inclined outwards, the respective diameters D′_{A} and D″_{A} of their axially inner edges being larger than the diameters D′_{B} and D″_{B} of their axially outer edges. The two seats 13′ and 13″ are extended axially outwards by two projections 15′ and 15″ of small height.

A first seat 13′, which by convention is intended to be mounted on the outside of a vehicle fitted with assemblies mounted according to the invention, is extended axially inwards by a frustoconical portion 17 inclined at an angle a relative to the axial direction. The axially inner edge of the frustoconical portion 17 is also the edge of the bearing surface 11 of the rim 10 situated axially on the outside of the vehicle.

This bearing surface 11 consists of two contact zones 111 and 112 separated by a circumferential groove 110. The diameter of the bearing surface 11 is D_{N}. The contact zone 112, which is axially nearest a second rim seat 13″ (conventionally intended to be mounted on the inside of the vehicle) is provided at its edge nearest the said second seat 13″ with a positioning projection 16 forming a stop. The latter is intended to prevent axial inward displacement of the support S which is designed to be mounted on the bearing surface 11.

The second seat 13″ is extended axially inwards by a ridge 14 of low height h (of the order of 3 to 4 mm). The ridge 14, together with the stop 16, delimits a mounting groove 12 for the positioning of a second tyre bead which is designed to be mounted on the said second seat 13″.

The support S shown in FIG. 1, made of a rubber material, has in this example an axial width l much smaller than the axial width L of the bearing surface 11, since in the example of FIG. 1 it equals 0.5 L. The width of the safety support S, in particular in the case when the circumferential groove 110 is present, must be larger than the width l₁ of the said groove. Having regard to the small axial width of the support S, the first part 111 of the bearing surface 11 is only useful for mounting and removing the support S.

The bearing surface 11 of the rim 10 is provided on the radially upper face of the contact zone 112 with a circumferential groove 115 which, viewed in meridian cross-section, is in the form of a semicircle with a small radius of the order of 4.5 mm, i.e. essentially the same value as the height of a projection 15′ or 15″.

The radially inner face of the support S is for example provided with a plurality of circumferential protuberances 30 formed at regularly spaced intervals on a same circle and designed to cooperate with the groove 115 in the contact surface 112 to prevent any axial displacement of the support S towards the first seat 13′ when in service.

Each protuberance 30 can consist of the same rubber material as that of the support S and can be reinforced or not. These protuberances 30 are preferably located axially between the edge of the radially inner face of the said support S axially nearest the seat 13′ and the middle of the said face. The axial distance Vₓ separating the central axis of each protuberance 30, which is also the central axis of the groove 115, from the edge of the contact zone 112 located on the outside of the vehicle, is between 0.1 and 0.2 times the axial width of the support S, this in particular so as to obtain better centring of the support S on the zone 112.

French patent specification FR-A-2 720 977 describes a process for mounting a tyre and a removable safety support on such a rim, this process comprising the following stages.

The said second tyre bead is offered to the rim on the side of the said first seat and the said second bead is then slipped axially over the rim bearing surface so as to introduce it into the mounting groove. The support is positioned on the rim and the said first tyre bead is then mounted on the said first seat. An extraction stage of the said second bead is then carried out, consisting of its extraction from the said groove so as to bring it axially outside the projection of the said second seat. Finally, the said second bead is mounted on the said second seat.

To carry out this extraction stage one can work manually using tools of the lever type, so as to extract the said second bead progressively from the mounting groove.

Alternatively, an automated method as described in European patent EP-A-1 008 467 can be used, first by using an insertion finger to create a local space between the said second bead and the said axially inner ridge of the said second seat, secondly by inserting into this local space a gripping hook so that it occupies a contact position on the inside face of the said second bead, and thirdly by pivoting the gripping hook in the said contact position so that it brings the said second bead to a local extraction position radially and axially outside the said second seat, and then fourthly by extracting the said second bead all round the circumference of the tyre.

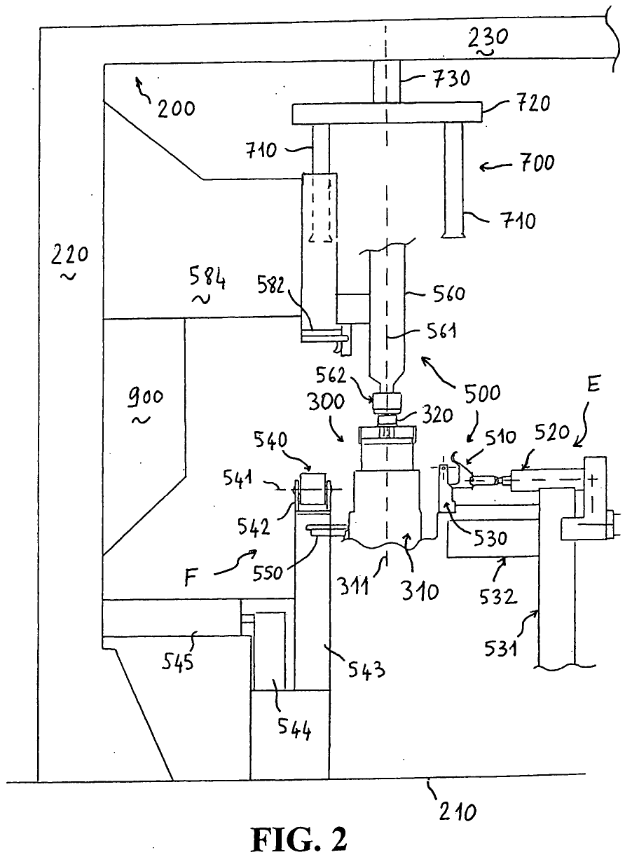

As can be seen in FIG. 2 of that document, the second stage above consists in pivoting the gripping hook on a first pivoting axis located radially outside the said groove, such that the hook occupies the said contact position, and the said third stage consists in pivoting the hook in the said contact position under the action of a means of control to which the hook is coupled, in such manner that the latter pivots around a second fixed pivoting axis located radially inside the said groove.

This third stage is carried out by means of a lever distinct from the hook itself, which is articulated on the one hand to the hook via the first pivoting axis and on the other hand to a fixed support via the second pivoting axis, this lever being designed to pivot on the said second axis via the said control means.

European patent specification EP-A-1 048 496 describes a process and device for mounting, in which the first tyre bead and the safety support are simultaneously fitted on the rim by the progressive application of an axial force to the said first bead, which is itself in contact with the adjacent face of the support. The tool for applying the axial force is a freely rotating roller and this positioning is effected during a rotation of the rim which also drives the tyre and the support in rotation.

This process is above all appropriate in the case of a support which, in a position where it has been fitted on the bearing surface of the rim, is in contact with the first bead or very close to it, while being less so in the case of a “lighter” support which, in the mounted condition, is some considerable distance away from the inside face of each bead, for example of the order of about 10 centimetres. During the mounting of a tyre with such a support on a rim, experience shows that the said first bead does not truly follow the movement of the support during the positioning of the said support on the bearing surface of the rim.

One purpose of the present invention is to propose a process for mounting on a wheel rim, on the one hand a tyre comprising first and second beads respectively designed to be mounted on a first and a second seat of the said rim and, on the other hand, a safety support designed to be mounted in the inside space of the said tyre on a bearing surface of the said rim in order to support the tread of the tyre in the event of a fall in its internal pressure, the said first and second seats each being axially extended on the outside by a projection, the axially inner edge of at least one of the said seats describing a circle of diameter larger than that of the circle described by the axially outer edge of the same seat, the said first seat being axially connected to the inside of the said bearing surface, which is connected to the said second seat by a mounting groove, the said process comprising in a known way the following stages:
(a) the said tyre provided with the said support in its inside space is brought up to the said rim, offering the said second bead on the side of the said first seat, and then
(b) the said second bead is slipped axially over the said bearing surface so as to introduce it into the said groove and to place the said support partially in position on the said bearing surface, the said first bead then being axially outside the said first seat, and then
(c) the said support is fitted fully over the said bearing surface, and then
(d) the said first bead is mounted on the said first seat, and then
(e) the said second bead is extracted from the said groove so as to bring it axially outside the said projection of the said second seat, and then
(f) the said second bead is mounted on the said second seat,
which in particular optimises the effectiveness of the extraction stage (e) by allowing the automated and industrial-scale mounting of tyres provided with safety supports for any type of support, whatever its dimensions and however it is mounted on the wheel rim.

To this end, the mounting process according to the invention is such that, before carrying out the said stage (b), a means for extracting the said second bead is positioned at the bottom of the said groove and, to carry out the said stage (e), the said second bead is guided axially towards the outside of the said groove and that of the said second seat by pivoting the said extraction means around an axis located radially inside the said rim.

Note that this initial positioning of the extraction means at the bottom of the said groove makes it unnecessary to create later a local space between the second bead and the axially inner ridge of the second seat (for example by means of the insertion finger described in EP-A-1 008 467), in order to allow the insertion of a hook to extract the said second bead.

Note also that this initial positioning allows the second bead to be extracted without damaging it in any way.

According to another feature of the invention, the said rim, tyre and support are all rotated together around the axis of revolution of the said rim in order to carry out the said stage (e) all round the circumference of the said rim.

According to another characteristic of the invention:
(i) before carrying out the said stage (c), the said first bead is displaced radially towards the outside of the said first seat at the same time as a means for pushing the said support radially to the top of the latter is brought in, and
(ii) to carry out the said stage (c), the said pushing means is displaced axially inwards so that it progressively pushes the said support over the said bearing surface towards the said second seat, while at the same time the said first bead is kept axially and radially outside the said first seat as the rim, the tyre and the support are all rotated about the revolution axis of the said rim.

Note that operation (i) allows satisfactory control of the conditions for positioning the support.

Note also that the positioning of the said first bead during operation (ii) avoids any contact between it and the top of the support.

According to another feature of the invention, before operation (i) an axial force is applied locally to a sidewall of the said tyre that extends the said second bead, so as to bring the said first bead axially towards the outside of the said support and to create a local space between the said first bead and the lateral adjacent edge of the said support, large enough to be able to displace the said first bead radially outwards.

According to a preferred manner of implementing the invention, the said mounting process consists in maintaining the revolution axis of the said rim with the said support and tyre in the direction of gravity when carrying out the said stages (a) to (f).

Another purpose of the present invention is to propose a unit for carrying out the above mounting process, the said unit comprising reception means designed to receive the said wheel with its support and tyre and to drive these in rotation about its revolution axis, and extraction means designed to extract the said second bead from the said mounting groove by means of a hook, and comprising also a lever articulated to a fixed pivoting axis and designed to pivot the said hook around the said fixed axis via means for controlling the said lever, which also enables the automated and efficient serial mounting on an industrial scale of tyres provided with safety supports, regardless of the type of support.

To this end, a unit according to the invention is such that the said hook is formed on the said lever.

Note that this monoblock structure for the hook and lever facilitates the operation of extracting the second bead.

According to a preferred embodiment of the invention, the said control means comprise a jack whose shaft is articulated to the said lever so that a variation in the stroke of the jack pivots the hook about the fixed pivoting axis.

According to another characteristic of the invention, the said hook is curved so as to match the contour of the bottom of the said mounting groove.

According to another characteristic of the invention, a “U”-shaped recess designed practically to match the contour of the said second seat, is formed in the said lever between the said hook and the said fixed pivoting axis.

According to another characteristic of the invention, the said mounting unit comprises means for positioning the said extraction means and the said control means in the axial and radial directions relative to the said rim.

According to another characteristic of the invention, the said mounting unit comprises a gripping finger whose free end has a curvature enabling it to grip the said first bead, means for pushing the said support being mounted on the said end, on the side of the said finger opposite the said curvature, the said finger being connected to control means for controlling its displacement on the one hand in the radial direction relative to the said rim so as to be able to move the said first bead radially outwards, and on the other hand in the axial direction relative to the rim so that the said pushing means pushes the said support onto the rim and the side of the said finger facing the said curvature forms a slide ramp for the said first bead during this pushing movement.

According to an embodiment of the invention, the said gripping finger is provided, on the same side where the said pushing means are mounted and opposite to the said end, with a mounting roller designed to mount the said first bead on the said first seat, the said gripping finger being pivot-mounted so that, in alternation, the said pushing means and the said mounting roller can be positioned axially in a manner adjacent to the said support and to the said first bead, respectively, by pivoting the gripping finger through 180°.

According to a preferred embodiment of the invention, the said receiving means is designed to immobilise the said axis of rotation of the said wheel in the direction of gravity.

The above characteristics of the present invention, and others as well, will be better understood on reading the following description of an example embodiment of the invention, given for illustrative and not limiting purposes, the said description referring to the attached drawings which show:

FIG. 1: Meridian cross-section of a known wheel rim that can be used to implement the mounting process according to the invention,

FIG. 2: Schematic and partial elevation of a mounting unit according to the invention,

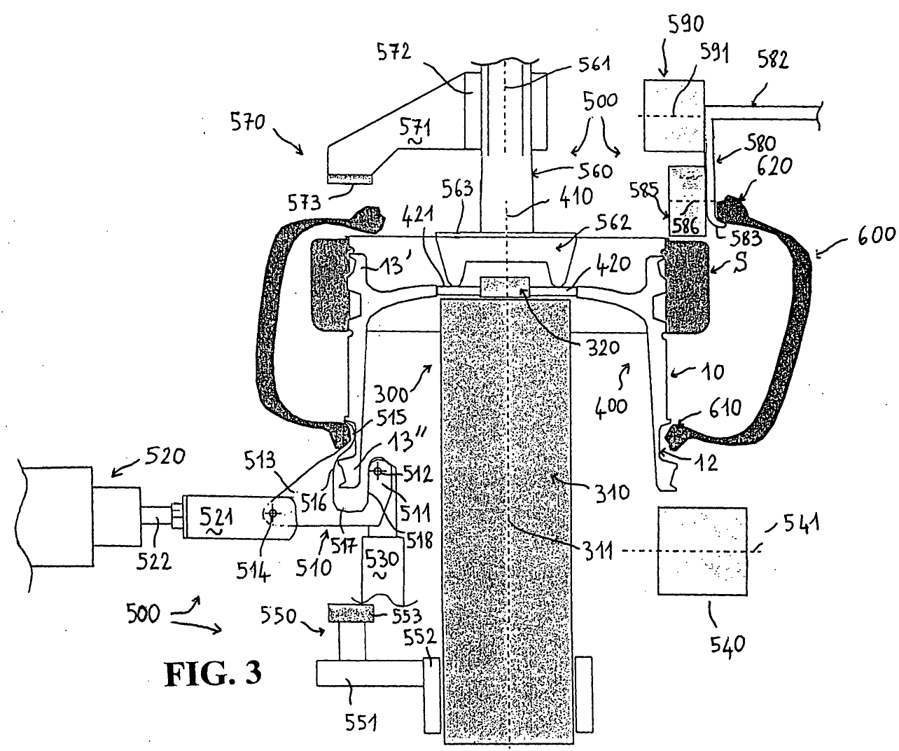

FIG. 3: Schematic view of means for mounting the unit of FIG. 2, according to a first example embodiment of the invention, these means being provided with a tyre and a first example of a support, which are shown during mounting onto the rim of FIG. 1,

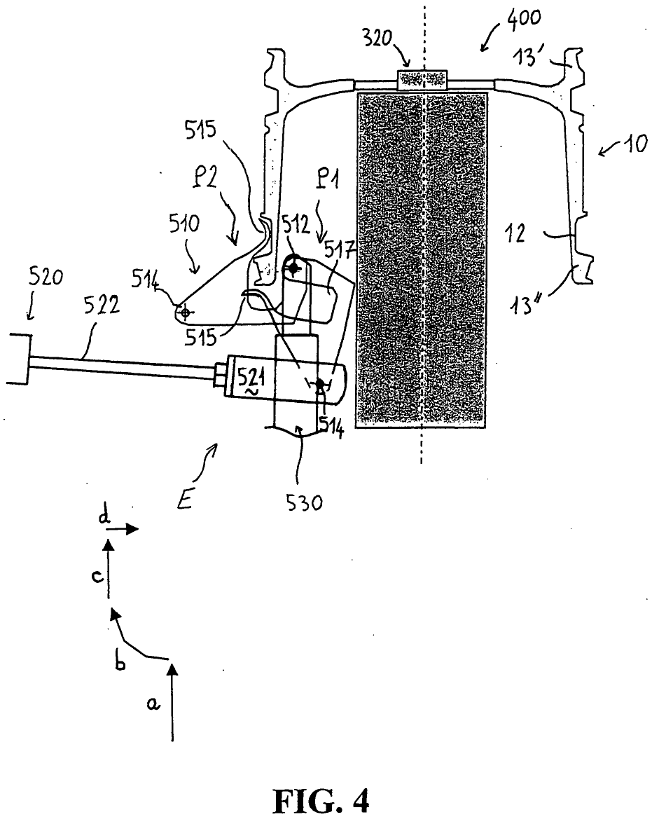

FIG. 4: Schematic view of the mounting means of FIG. 3 at a first moment during a first stage of the mounting process according to the invention,

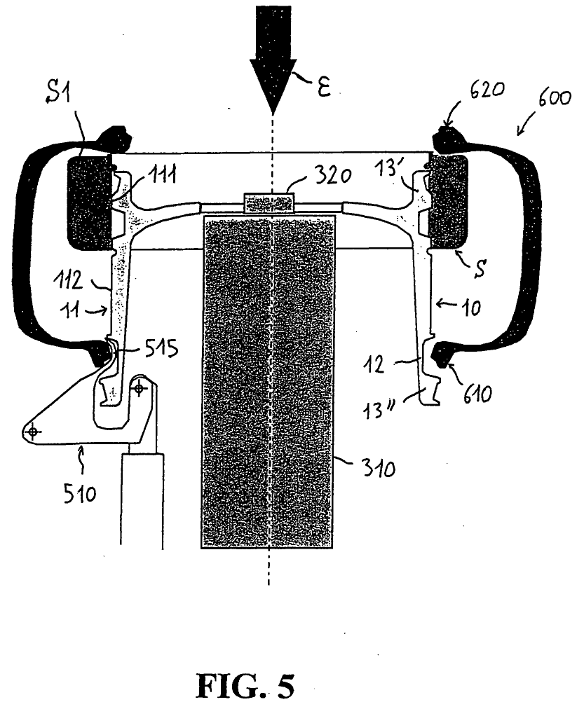

FIG. 5: Schematic view of the mounting means of FIG. 3 at a second moment during the said first phase,

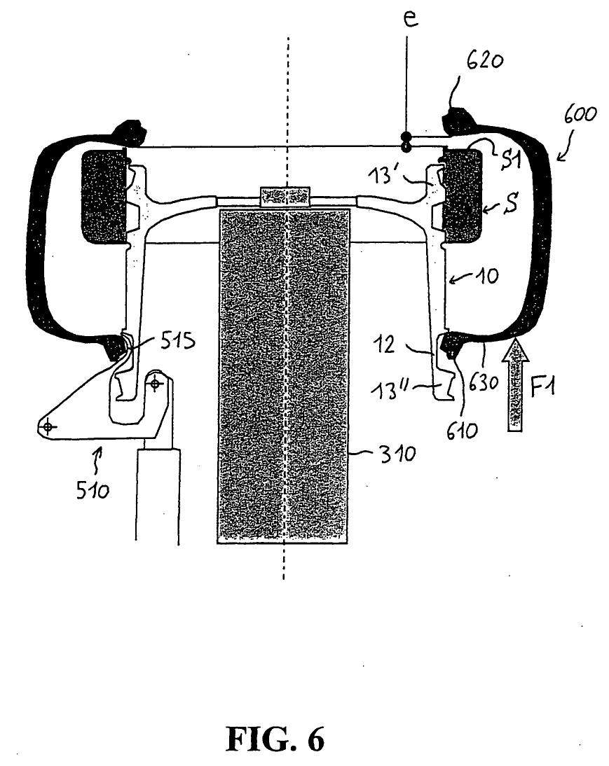

FIG. 6: Schematic view of the mounting means of FIG. 3 at a first moment during a second stage of the mounting process according to the invention,

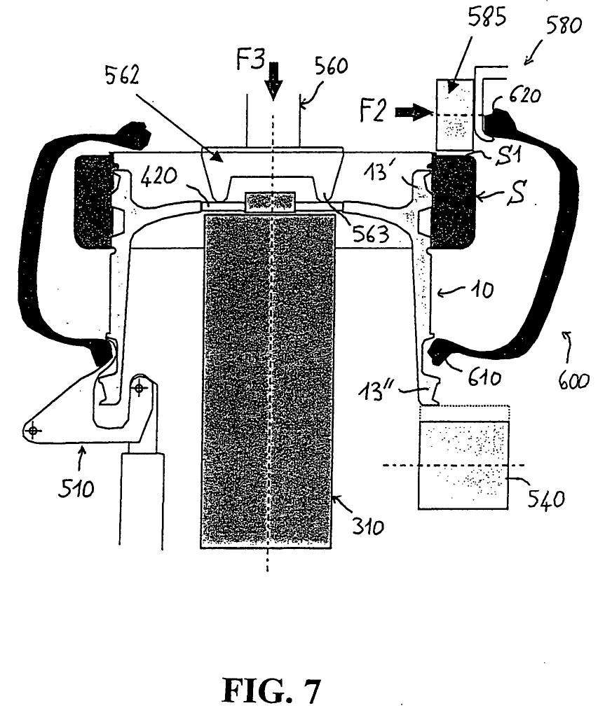

FIG. 7: Schematic view of the mounting means of FIG. 3 at a second moment during the said second stage,

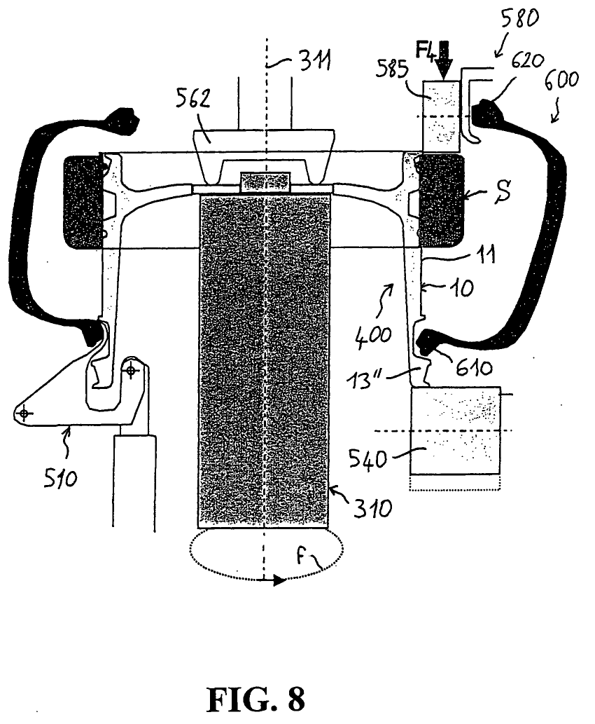

FIG. 8: Schematic view of the mounting means of FIG. 3 at a third moment during the said second stage,

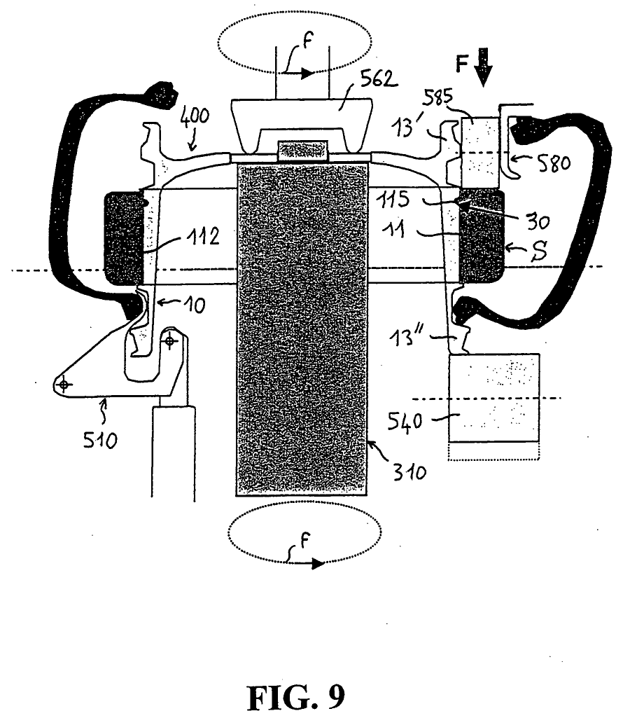

FIG. 9: Schematic view of the mounting means of FIG. 3 at a fourth moment during the said second stage,

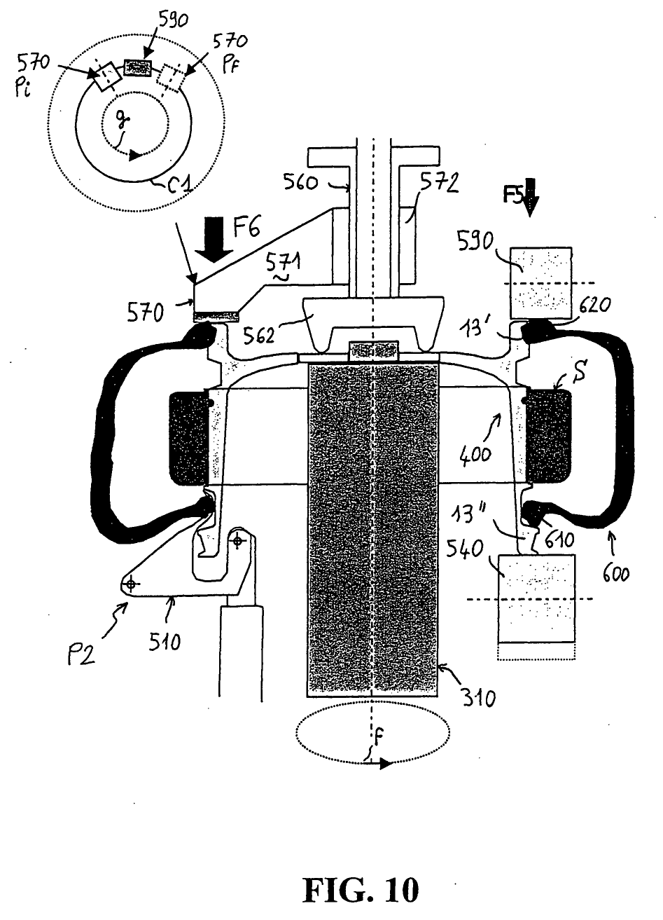

FIG. 10: Schematic view of the mounting means of FIG. 3 at a first moment during a third stage of the mounting process according to the invention, with a detail view illustrating an aspect of this first moment, viewed from above the said mounting means,

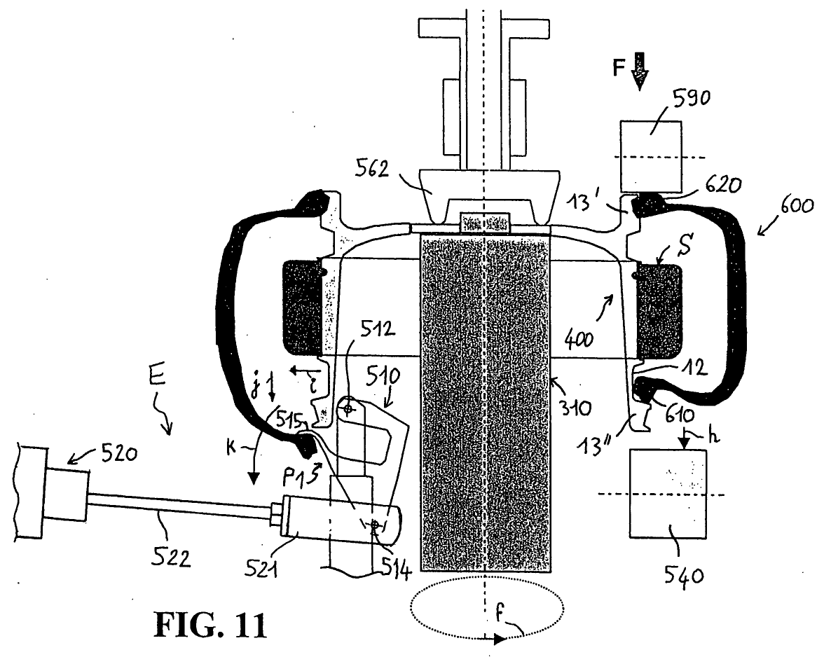

FIG. 11: Schematic view of the mounting means of FIG. 3 at a second moment during the said third stage,

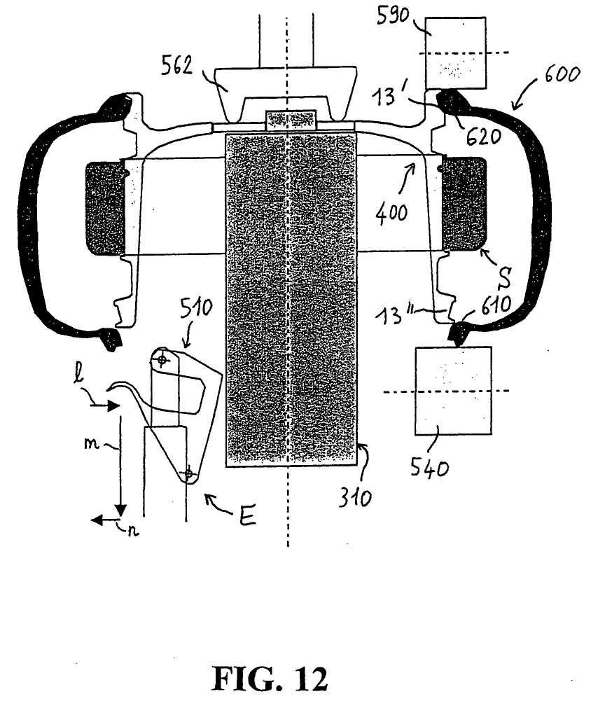

FIG. 12: Schematic view of the mounting means of FIG. 3 at a third moment during the said third stage,

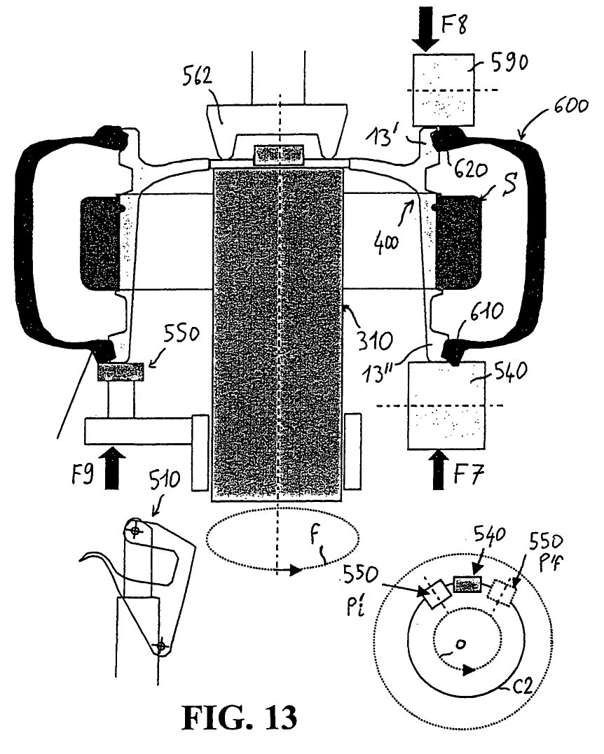

FIG. 13: Schematic view of the mounting means of FIG. 3 at a first moment during a fourth stage of the mounting process according to the invention,

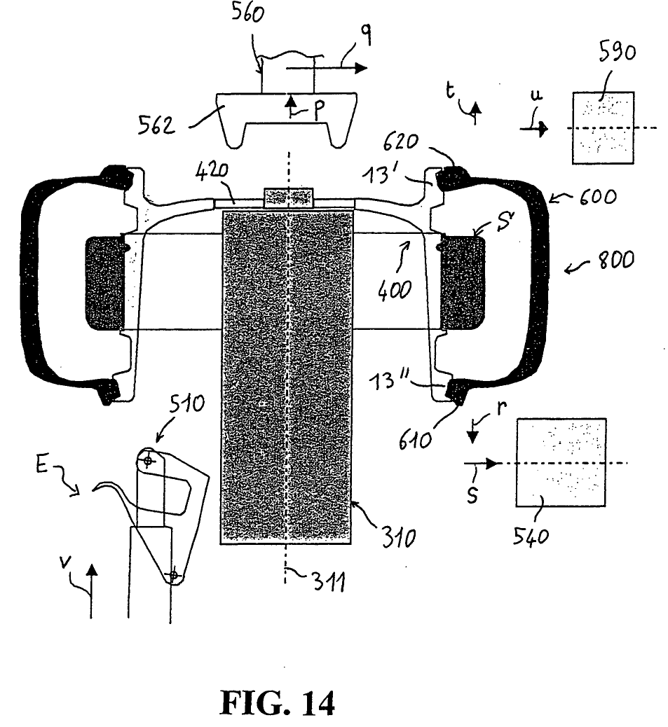

FIG. 14: Schematic view of the mounting means of FIG. 3 at a second moment during the said fourth stage, illustrating how a mounted assembly is obtained,

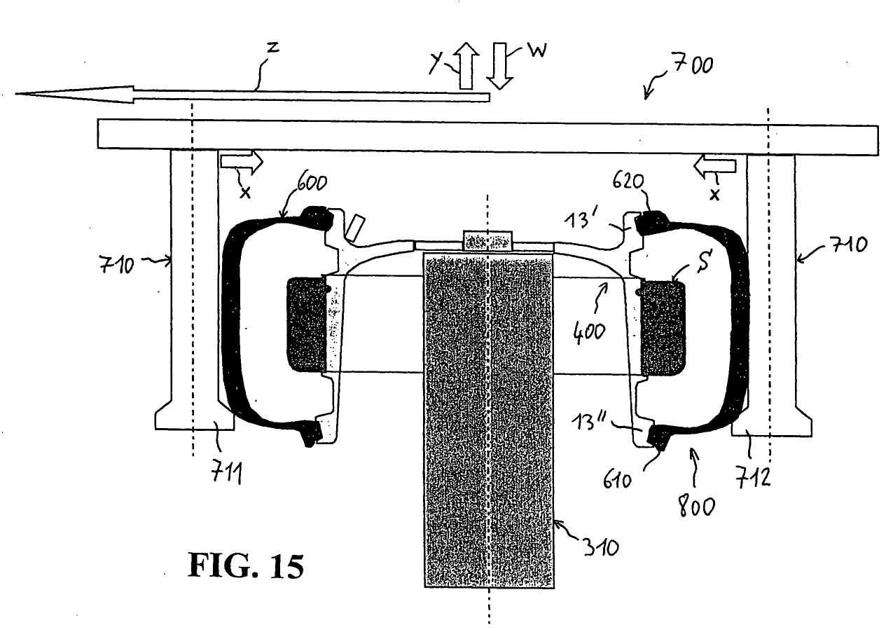

FIG. 15: Schematic view of part of the mounting unit of FIG. 2 which is designed for the extraction of the mounted assembly of FIG. 14 of the said mounting means and,

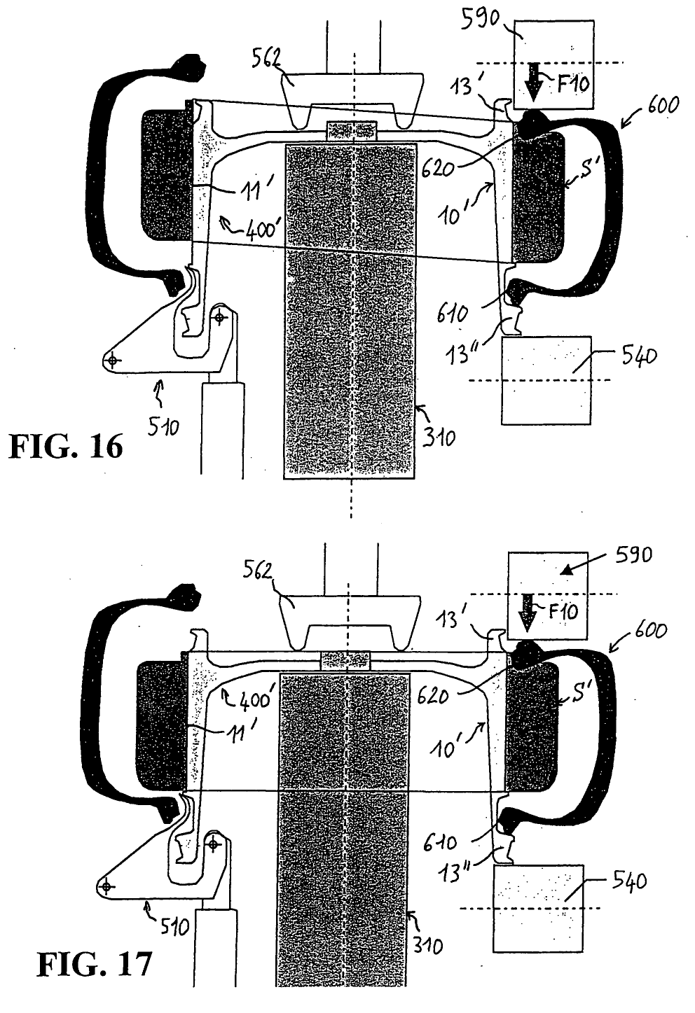

FIGS. 16 and 17: Schematic views of mounting means of the unit of FIG. 2 according to a second example embodiment of the invention, these means being provided with a tyre and a second example of a support, represented at two successive mounting moments onto a rim different from that of FIG. 1, replacing the second stage illustrated in FIGS. 6 to 9 for the said first example according to the invention.

FIG. 2 is a schematic illustration of the essential elements constituting a mounting unit according to the invention. This unit comprises essentially:
a frame 200 in the form of a gantry,
a rotating reception means 300 mounted on the base 210 of the frame 200 and designed to receive a wheel 400 comprising the rim 10 of FIG. 1 (the wheel 400 can be seen in FIG. 3) so that the revolution axis 410 of the wheel 400 is fixed in the vertical direction, and designed to drive the wheel 400 in rotation about the said axis 410,
mounting means 500 for a tyre 600 and a safety support S on the wheel 400,
withdrawing means 700 for removing a mounted assembly 800 (which can be seen in FIG. 14) from these mounting means 500, and
a control desk 900 provided for controlling all the movements of the receiving means 300, the mounting means 500 and the withdrawing means 700.

The rotating reception means 300 comprises a shaft 310 whose axis 311 is perpendicular to the base 210, to the end of which is coupled a hub 320 designed to cooperate with the disc 420 of the wheel 400 (see FIG. 3) and to be driven in rotation about its axis 311 by the said shaft 310.

As can be seen in FIG. 3, the receiving means 300 and the mounting means 500 are arranged in the mounting unit according to the invention in such manner that the outer face 421 of the wheel disc 420, which is to be mounted on the outside of the vehicle to which the wheel 400 is fitted, faces upwards in the said unit. As a result, the said first rim seat 13′, which is also to be fitted on the said outer side, is positioned above the said second rim seat 13″.

As shown in FIGS. 2 and 3, below the hub 320 and in the axial direction of the axis 311 of the shaft 310, the mounting means 500 comprise essentially the following elements.

FIG. 3 in particular shows a means for extraction 510 designed to extract the second bead 610 of the tyre 600, which is to be fitted on the second rim seat 13″, from the mounting groove 12 of the rim 10 under the control of a jack 520, for example of the pneumatic type.

According to the invention, FIG. 3 shows that the said extraction means 510 consist of a lever pivot-mounted, on the one hand, at one of its ends 511 via a pivot 512 which is mounted fixed on a support 530 and is designed to be positioned radially inside the second rim seat 13″ and, on the other hand, at its other end 513 via a pivot 514 mounted movably relative to the said support 530, being mounted on a tab 521 which coaxially extends the shaft 522 of the jack 520 so that this pivot 514 can describe an arc of a circle around the pivot 512 under the action of the jack 520.

The lever 510 comprises a hook 515 which extends between the said ends 511 and 513 and forms in essence a right-angled triangle with the said “movable” end 513 and a first edge 516 of a U-shaped recessed element 517 which connects the said hook 515 to the said “fixed” end 511. The second edge 518 of the recessed element, which is parallel to the previous edge, contains at its top the “fixed” end 511 of the lever 510.

This recessed element 517 is designed practically to match the contour of the second rim seat 13″, so as to allow the lever 510 to pivot on the “fixed” pivot 512 without contact between the hook 515 or the edges 516, 518 of the recessed element 517 and the second seat 13″.

The recessed element 517 is such that the two ends 511 and 513 of the lever 510 are connected together by an “L” which in practice forms part of the said lever 510.

Note that the hook 515 initially extends the first edge 516 of the recessed element 517 in the direction of the second edge 518 obliquely, making an acute angle, and then the hook 515 curves slightly inwards along a curvature directed towards the said first edge 516, so that the hook 515 matches the contour of the bottom of the mounting groove 12 of the rim 10 in order to extract the second bead 610 from the said groove 12.

As shown in FIG. 2, the extraction block E comprising the jack 520, the extraction means 510 and the support 530 is connected to two positioning means 531 and 532, each being for example of the screw-and-nut type driven by an electric motor. An axial positioning means 531 is designed to adjust the height position of the said extraction block (i.e. in the axial direction of the axis 311), while a radial positioning means 532 is designed to adjust the position of the extraction block in the radial direction of the said axis 311 (i.e. the radial direction of the wheel 400).

FIG. 3 in particular also shows a lower mounting roller 540 which is mounted to rotate freely on an axis 541 perpendicular to the said axis 311 via tabs 542 which extend a vertical support 543, on the other side of the extraction means 510 relative to the said axis 311, the said roller being designed to mount the said second bead 610 onto the second seat 13″. Similarly to the extraction block E, the block F comprising the support 543 and the roller 540 is connected to two positioning means 544 and 545 to control its position in the aforesaid axial and radial directions.

FIG. 3 also shows a lower slide block 550 mounted on an arm 551 which is connected to the said shaft 310 in the radial direction of the latter by means of a bearing 552, such that the slide block 550 can pivot around the shaft 310 as the latter rotates under the control of control means (not shown, for example of the cotter type), the bed-plate 553 of this slide block 550 being parallel to the axis 541 of the said roller 540 and being designed to keep the said second bead 610 in its mounted position on the second seat 13″ during the pivoting of the slide block 550.

As can be seen in FIGS. 2 and 3, above the hub 320 in the axial direction of the axis 311, the mounting means 500 also comprise the following elements.

FIG. 3 in particular shows a complementary holding element 560 attached interdependent to an upright 220 of the frame 200 such that the axis 561 of the holding element 560 coincides with the axis 311 of the shaft 310. This holding element 560 is provided at its free end with a thrust endpiece 562, for example in the form of a disc, designed to keep the wheel 400 in position on the hub 320 while the latter is rotating, bearings 563 being provided between the said endpiece 562 and the said holding element 560.

FIG. 3 also shows an upper slide block 570 fitted at the end of an arm 571 which is attached to the holding element 560 in its radial direction via a bearing 572, such that the slide block 570 can pivot around the holding element 560 independently of the latter under the control of control means (not shown), the bed-plate 573 of the slide block 570 being parallel to that of the lower slide block 550 and being designed to keep the first bead 620 of the tyre 600 in its mounted position on the said first seat 13′ during the pivoting of the slide block 570.

FIG. 3 also shows a gripping finger 580 formed by a bar extending in the vertical direction of the axis 561 of the holding element 560, which is also attached solidly to the upright 220 of the frame 200 via a horizontal connecting arm 582 designed to move radially and to be able to pivot through 180° around its axis under the control of control means (not shown). The free end 583 of this finger 580 has a curvature designed to be orientated towards the outside of the rim 10 and which is shaped so as to grip and push the said first bead 620 locally towards the outside in the radial direction of the tyre 600, under the control of control means 584 (see FIG. 2) when the said end 583 is in a low position determined by the pivoting of the said connecting arm 582.

A thrust roller 585 is mounted to rotate freely at the end 583 of the finger 580 via a horizontal rotation axis 586 which is parallel to the said axis 541 of the lower roller 540, on the face of the finger 580 opposite to that orientated towards the said curvature, such that the cylindrical surface of the roller 585 projects axially beyond the said end 583 (i.e. vertically downwards). The roller 585 is designed to push the support S inside the tyre 600 in the axial direction of the latter, under the control of the said control means 584, also in the aforesaid low position of the said end 583.

Besides, on the same gripping finger 580 is mounted an upper mounting roller 590 (only visible in FIG. 3), whose rotation axis 591 is parallel to that of the thrust roller 585 and which is also mounted to rotate freely on the face of the finger 580 opposite to that orientated towards the said curvature and opposite the said end 583. The roller 590 has a cylindrical surface of height (i.e. in the direction of its rotation axis 591) larger than that of the thrust roller 585, such that the roller 590 is able to mount the said first bead 620 onto the said first seat 13′ when the end 583 is in a high position determined by pivoting the connecting arm 582 through 180°.

The withdrawing means 700 of a mounted assembly 800 of the mounting means 500 (see FIG. 2) consists essentially of vertical arms 710 to grip the said assembly 800, which are mounted so that they can move relative to one another on a plate 720 fitted and able to slide on a horizontal cross-bar 230 belonging to the frame 200, under the control of vertical and horizontal sliding means 730.

The control desk 900 is connected electrically to all the aforesaid reception, mounting and withdrawal means 300, 500 and 700, and the electronic control system it contains will not be described in detail in the present application.

A mounting unit according to the invention operates as follows.

A first stage of the mounting process according to the invention is illustrated in FIGS. 4 and 5.

As shown in FIG. 4, an operator first positions the wheel 400 on the hub 320 in a locked position.

He then automatically implements all the operations described below, by initially actuating the electronic control system of the desk 900.

This electronic control system first displaces the extraction means 510 so that it moves essentially from a position P1 in which the hook 515 of the lever 510 is axially outside (i.e. lower than) the second rim seat 13″, to a position P2 in which the hook 515 is located at the bottom of the groove 12 of the rim 10.

Before this position PI, the electronic control system has actuated the axial positioning means 531 so that the extraction block E (jack 520, extraction means 510 and support 530) is displaced in vertical and ascending translation in the direction of the arrow until it is at an appropriate height corresponding to the position P1. In the example of FIG. 4, this position P1 is such that the fixed pivot 512 of the support 530 is located radially inside the second rim seat 13″and facing the latter.

The electronic control system moves the lever 510 from position P1 to position P2 by actuating, at a first moment, the jack 520 so that its stroke is reduced to an extent that it causes the said “moving” pivot 514, via the tab 521, to describe an arc of a circle around the said “fixed” pivot 512 (see arrow b) so that the hook 515 of the lever 510 also describes a circular arc axially towards the inside of the second seat 13″ and radially towards the outside of the latter.

When the hook 515 is radially outside the second seat 13″, at a second moment the electronic control system, if necessary, slightly adjusts the axial position of the extraction block E by actuating the axial positioning means 531 (for example, a vertical ascending translation by a few mm, see arrow c) and consequently that of the hook 515, so as to bring the latter opposite the mounting groove 12 of the rim 10 while the pivoting of the lever 510 around the pivot 512 continues.

Then, at a third moment, the electronic control system slightly adjusts the radial position of the extraction block E by actuating the radial positioning means 532, to position the hook 515 on the bottom of the mounting groove 12 (see arrow d, which illustrates this radial translation towards the inside of the rim 10).

Note that the location of the “fixed” pivot 512 in position P1 and the shape of the recess 517 permit the lever 510 to pivot without interference by the second seat 13″.

As can be seen in FIG. 5, the electronic control system then positions the tyre 600 with the support S inside it onto the rim 10 (see arrow ε), such that the second bead 610 sits in the mounting groove 12, radially over the hook 515, and the first bead 620 occupies a position axially outside the first seat 13′, as also does a lateral edge S1 of the support S. It can be seen that the support S is then mounted over both of the said zones 111 and 112 of the bearing surface 11 of the rim 10.

A second stage of the mounting process according to the invention is illustrated in FIGS. 6 to 9.

As shown in FIG. 6, the electronic control system then causes an axial force to be applied locally (symbolised in FIG. 6 by the arrow F1) to the sidewall 630 of the tyre 600 that extends the second bead 610, so as to move the first bead 620 axially towards the outside of the support S and create a local space e (of at least 10 mm, for example) between the said bead 620 and the adjacent lateral edge S1 of the support S large enough to allow insertion of the gripping finger 580.

As shown in FIG. 7, the electronic control system then, on the one hand, inserts the finger 580 in the said local space e and displaces the first bead 620 radially outwards by applying a local radial force (symbolised by the arrow F2) and, on the other hand, applies the thrust endpiece 562 of the holding element 560 against the wheel disc 420 (this application being symbolised by the axial force F3). FIG. 7 shows that the effect of the radial force F2 is also to bring the cylindrical surface of the thrust roller 585 to a radially centred position against the adjacent lateral edge S1 of the support S.

In addition, the electronic control system brings in the lower mounting roller 540 via the said positioning means 544, 545, adjusting its position in the axial and radial directions until it is as near as possible to the second rim seat 13″.

As shown in FIG. 8, the electronic control system then begins rotating the shaft 310 (see the circular arrow f), the result being to drive the assembly (wheel 400, support S, tyre 600) all together in rotation about the axis 311 and, concomitantly, the electronic control system moves the gripping finger 580 in the axial direction towards the inside of the tyre 600 so that the roller 585 progressively pushes the support S onto the bearing surface 11 of the rim 10 in the direction of the second seat 13″ (this push being symbolised by the downward vertical force F4). FIG. 8 shows that this driving of the assembly (wheel 400, tyre 600 and support S) in rotation relative to the gripping finger 580 allows the support S to be moved axially inwards all round the circumference of the bearing surface 11 of the rim 10.

In addition, the electronic control system brings in the lower mounting roller 540 until it is immediately under the second rim seat 13″.

As can be seen in FIG. 9, the electronic control system continues pushing the support S axially inwards onto the bearing surface 11 by means of the roller 585 while maintaining the rotation of the assembly (wheel 400, support S and tyre 600) and while keeping the lower roller 540 under the second seat 13″, until the circumferential protuberances 30 of the support S lodge in the circumferential groove 115 of the said bearing surface 11. FIG. 9 shows that the support S is thereby immobilised on the rim's bearing surface 11, and that the entire radially lower face of the support S is then mounted on the zone 112 of the said bearing surface 11.

A third stage of the mounting process of the invention is illustrated in FIGS. 10 to 13.

As can be seen in FIG. 10, the electronic control system withdraws the gripping finger 580 (not shown) axially outwards, the result being to position the first bead 620 axially outside the first rim seat 13′, this withdrawal taking place after having momentarily interrupted the rotation of the assembly (wheel 400, support S and tyre 600). The electronic system then causes the finger 580 to pivot through 180° around the connecting arm 582, and this brings the upper mounting roller 590 axially into contact with the first bead 620 on the first seat 13′.

After re-starting the rotation of the assembly (wheel 400, support S, tyre 600), the electronic control system then moves the roller 590 inwards so that the latter pushes the first bead 620, to mount it on the first seat 13′, as shown in FIG. 10 (this pushing action being symbolised by the arrow F5), while at the same time the electronic system applies the said upper slide block 570 against the first bead 620 by means of the said arm 571 (see arrow F6) while pivoting the slide block 570 around the holding element 560 and in contact with the bead 620, over a circular arc C1 shown in the detail view included in FIG. 10.

In this detail view, it can be seen that the said circular arc C1 is for example described between an initial position Pi in which the slide block 570 is immediately adjacent to the upper mounting roller 590 on one side thereof, in a rotation direction (see the circular arrow g) in which the slide block 570 first moves away from the roller 590 and as far as a final position Pf in which the said slide block 570 is immediately adjacent to the said roller 590 on the other side thereof. Thus, the path followed by the slide block 570 is symmetrical relative to the roller 590 in this example embodiment.

Note that the pivoting of the slide block 570 in contact with the first bead 620 allows the entire circumference of the latter to be kept in the mounting position on the seat 13′ obtained by the action of the mounting roller 590.

As can be seen in FIG. 11, the electronic control system withdraws on the one hand the upper slide block 570 (not shown) from the first bead 620 while keeping the upper mounting roller 590 against the said bead 620, and on the other hand the lower mounting roller 540, while causing it to move axially towards the outside of the second seat 13″ (see arrow h).

At the same time, while still maintaining the rotation of the assembly (wheel 400, support S, tyre 600), the electronic control system moves the extraction lever 5 10 from the said position P2 (common to FIGS. 4 and 10), in which the hook 515 is located radially under the second bead 610 at the bottom of the mounting groove 12, to the said position P1 (illustrated in FIGS. 4 and 11) in which the hook 515 is located axially under the said bead 610 and axially outside the second rim seat 13″.

The electronic system moves the lever 515 from position P2 to position P1 by carrying out the operations mentioned above in connection with FIG. 4 in the reverse order.

Thus, at a first moment it actuates the radial positioning means 532 to raise the extraction block E and, consequently, the hook 515 radially outside the mounting groove 12 (see the arrow i illustrating this radial translation towards the outside).

Then, at a second moment the electronic system actuates the axial positioning means 531 to move the extraction block E vertically downwards (see arrow j) and consequently so too the hook 515, so that the latter can then pivot around the pivot 512 without interference.

Then, at a third moment it actuates the jack 520, increasing its stroke to an extent such that, via the tab 521, it causes the second “moving” pivot 514 to describe a circular arc around the said “fixed” pivot 512 (see arrow k) so that the hook 515 also describes a circular arc axially towards the outside of the second seat 13″.

As shown in FIG. 11, the pivoting of the lever 510 about the pivot 512 results, on the one hand, in extracting the second bead 610 from the mounting groove 12, by the fact that being guided by the curvature of the hook 515 during this pivoting, the bead 610 is pushed axially outside the groove 12 and, on the other hand, in bringing the bead 610 axially outside the second seat 13″.

As shown in FIG. 12, this extraction of the second bead 610 axially outside the second seat 13″ takes place all round the circumference of the said bead 610 by virtue of the concomitant rotation of the tyre 600 and wheel 400. Following this extraction, FIG. 12 shows that the lower mounting roller 540 is axially under the second bead 610. The electronic control system then stops the rotation of the shaft 310 and moves the extraction block E away from the bead 610 and the second seat 13″ by translations in the direction of the arrows l, m and n (i.e. radially inwards to withdraw the hook 515 from the second bead 13″, then axially outwards, and finally radially outwards, respectively).

A fourth stage of the mounting process according to the invention is illustrated in FIGS. 13 and 14.

As can be seen in FIG. 13, the electronic control system again actuates the shaft 310 to drive the assembly (rim 400, tyre 600, support S) in rotation and then moves the lower mounting roller 540 axially inwards so that it pushes the second bead 610 so as to mount it on the second seat 13″ (see arrow representing the force F7), while also exerting a thrust force on the upper mounting roller 540 (see arrow representing the force F8) so that the latter rests axially against the first bead 620 and the rim 400 in opposition to the said force F7.

At the same time as it brings about the thrust of the lower roller 540, the electronic system applies the lower slide block 550 directly under the second bead 610 (see arrow representing the force F9) while pivoting it in contact with the latter around the shaft 310 round a circular arc C2 represented in the detail view included in FIG. 13.

In that detail view it can be seen that the said circular arc C2 is for example described between an initial position P′i in which the slide block is immediately adjacent to the lower roller 540 on one side thereof, in a rotation direction (see circular arrow o) such that the slide block 550 first moves away from the roller 540 and as far as a final position P′f in which the said slide block 540 is immediately adjacent to the said roller 540 on the other side thereof. The path followed by the slide block 550 is thus symmetrical relative to the roller 540 in this example embodiment.

Note that the pivoting of the slide block 550 in contact with the second bead 610 contributes towards keeping the entire circumference of the latter in the mounted position on the seat 13″ obtained by the action of the mounting roller 540.

Then, as shown in FIG. 14 which represents the assembly (wheel 400, tyre 600, support S) in the final mounting position, the electronic control system stops the rotation of the shaft 310, withdraws the holding element 560 axially outwards and then radially away from the axis 311 of the shaft 310 (see arrows p and q) so as to withdraw the thrust end-piece 562 from the wheel disc 420, then withdraws the mounting rollers 540 and 590 axially and radially outwards (see arrows r, s, t and u), and returns the extraction block E to its initial position by a translation axially inwards (see arrow v, i.e. before the translation illustrated by the aforesaid arrow a in FIG. 4).

As can be seen in FIG. 15, the electronic control system then moves the vertical sliding means 730 (not shown) with which the withdrawal means 700 is provided, downwards such that the respective ends 711, 712 of the vertical gripping arms 710 are lowered essentially to the level of the second bead 610 of the tyre 600 (see arrow w), and then moves the said arms 710 closer to one another (see arrow x) so that the arms grip the mounted assembly 800.

The electronic control system then moves the said vertical sliding means 730 upwards (see arrow y) to disengage the mounted assembly 800 from the mounting means 500, and then moves the horizontal sliding means 740 (not shown) sideways (see arrow z) so as to transfer the mounted assembly 800 to an appropriate location for storage.

FIGS. 16 and 17 illustrate another example of the implementation of a mounting process according to the invention, in which the support S′ is wider than the support S shown in FIGS. 1 and 3 to 15, this support S′ being designed to be fitted over the full width (axial dimension) of the bearing surface 11′ of the rim 10′ and having no circumferential protuberance 30 for its mounting on the bearing surface 11′ (which has no groove 115).

For the description of the mounting process appropriate for this structure of the rim 10′ and support S′, reference can be made to the description given earlier in relation to FIGS. 4 to 15, except however for FIGS. 6 to 9 (which concern the said second stage of the process according to the invention), which are replaced by FIGS. 16 and 17.

As can be seen in FIG. 16, only the said upper mounting roller 590 is used to mount the support S′ on the rim 10′. To do this, the electronic control system on the one hand pushes this roller 590 against the first bead 620, which positions the said support S′ locally on the bearing surface 11′ (see arrow representing the force F10) and, on the other hand, positions the lower mounting roller 540 as close as possible to the second rim seat 13″, and then actuates the assembly (wheel 400′, tyre 600, support S′) in rotation by means of the shaft 310 so that the support S′ is correctly mounted on the bearing surface 11′ all around its circumference.

Note that the mounting process according to the invention enables a tyre provided with a safety support to be mounted effectively in an automated way and in a shorter time onto a wheel rim, whatever the type and dimensions of the support used.

1) Process for mounting on a rim (10, 10′) of a wheel (400, 400′), on the one hand a tyre (600) comprising a first and a second bead (620, 610) respectively intended for fitting on a first and a second seat (13′, 13″) of the said rim (10, 10′) and, on the other hand, a safety support (S, S′) designed for fitting in the inside space of the said tyre (600) on a bearing surface (11, 11′) of the said rim (10, 10′) with a view to supporting the tread of the said tyre (600) in the event of a fall in pressure inside the latter, the said first and second seats (13′, 13″) each being extended axially outwards by a projection (15′, 15″), the axially inner edge (17) of at least one of the said seats (13′, 13″) describing a circle of diameter larger than that of the circle described by the axially outer edge (15′, 15″) of the same seat (13′, 13″), the said first seat (13′) being axially joined to the inside of the said bearing surface (11, 11′), which is connected to the said second seat (13″) by a mounting groove (12), the said process comprising the following successive stages:
(a) the said tyre (600) provided with the said support (S, S′) in its inside space is placed on the said rim (10, 10′) by offering the said second bead (610) on the side of the said first seat (13′),
(b) the said second bead (610) is slipped axially over the said bearing surface (11, 11′) so as to introduce it into the said groove (12) and so as to place the said support (S, S′) partially in position over the said bearing surface (11, 11′), the said first bead (620) then being located axially outside the said first seat (13′),
(c) the said support (S, S′) is then fitted fully onto the said bearing surface (11, 11′),
(d) the said first bead (620) is mounted on the said first seat (13′),
(e) the said second bead (610) is extracted from the said groove (12) so as to bring it axially outside the said projection (15″) of the said second seat (13″),
(f) the said second bead (610) is mounted onto the said second seat (13″),
characterised in that
before implementing the said stage (b), a means (510) for extracting the said second bead (610) is positioned at the bottom of the said groove (12), and to implement the said stage (e), the said second bead (610) is guided axially towards the outside of the said groove (12) and of the said second seat (13″) by pivoting the said extraction means (510) around an axis (512) located radially on the inside of the said rim (10, 10′).

2) Mounting process according to claim 1,
characterised in that
the said rim (10, 10′), tyre (600) and support (S, S′) are driven together in rotation about the axis of revolution of the said rim (10, 10′) to implement the said stage (e) all round the circumference of the said rim (10, 10′).

3) Mounting process according to claims 1 or 2,
characterised in that
(i) before implementing the said stage (c), the said first bead (620) is moved radially towards the outside of the said first seat (13′) at the same time as a mean (585) for pushing the said support (S) radially is brought to the level of the latter, and
(ii) to implement the said stage (c), the said pushing means (585) is displaced axially inwards so that it progressively pushes the said support (S) onto the said bearing surface (11) in the direction of the said second seat (13″), and at the same time the said first bead (620) is kept axially and radially outside the said first seat (13′) while driving together in rotation the said rim (10), tyre (600) and support (S) about the revolution axis of the said rim (10).

4) Mounting process according to claim 3,
characterised in that
before operation (i), an axial force (F1) is applied to a sidewall (630) of the said tyre (600) that extends the said second bead (610), so as to bring the said first bead (620) axially towards the outside of the said support (S) and to create a local space (e) between the said first bead (620) and the adjacent lateral edge (S1) of the said support (S) large enough to be able to move the said first bead (620) radially outwards.

5) Mounting process according to any of the preceding claims,
characterised in that
it consists in maintaining the revolution axis of the said rim (10, 10′) provided with the said support (S, S′) and the said tyre (600) in the direction of gravity when implementing the stages (a) to (f).

6) Mounting unit for implementing the process according to any of the preceding claims, the said unit comprising a receiving means (300) designed to receive the said wheel (400, 400′) provided with the said support (S, S′) and the said tyre (600) and to drive it in rotation about its revolution axis, and an extraction means (510) designed to extract the said second bead (610) from the said mounting groove (12) by means of a hook (515) and comprising a lever (510) articulated on a fixed pivoting axis (512) and designed to pivot the said hook (515) around the said fixed axis (512) via a means (520) for controlling the said lever (510),
characterised in that
the said hook (515) is formed on the said lever (510).

7) Mounting unit according to claim 6,
characterised in that
the said control means (520) comprises a jack whose shaft (522) is articulated to the said lever (510) in such manner that a variation of the stroke of the said jack (520) causes the said hook (515) to pivot around the said fixed pivoting axis (512).

8) Mounting unit according to claims 6 or 7,
characterised in that
the said hook (515) has a curvature designed to match the contour of the bottom of the said groove (12).

9) Mounting unit according to claim 8,
characterised in that
a recess (517) in the shape of a “U”, designed practically to match the contour of the said second seat (13″), is formed in the said lever (510) between the said hook (515) and the second fixed pivoting axis (512).

10) Mounting unit according to any of claims 6 to 9,
characterised in that
it comprises means (531 and 532) for positioning the said extraction means (510) and the said control means (520) in the axial and radial directions relative to the rim (10, 10′).

11) Mounting unit according to any of claims 6 to 10,
characterised in that
it comprises a gripping finger (580) whose free end (583) has a curvature designed to grip the said first bead (620), a means (585) for pushing the said support (S) being mounted on the said end (583) on the side of the said finger (580) opposite to the said curvature, the said finger (580) being connected to control means (584) for controlling its displacement, on the one hand in the radial direction relative to the said rim (10) so as to be able to move the said first bead (620) radially towards the outside, and on the other hand in the axial direction relative to the said rim (10) so that the said pushing means (585) pushes the said support (S) onto the said rim (10) and the side of the said finger (580) facing the said curvature forms a slide ramp for the said first bead (620) during this pushing movement.

12) Mounting unit according to claim 11,
characterised in that
the said gripping finger (580) is provided on the said side where the pushing means (585) is fitted and opposite the said end (583), with a mounting roller (590) designed to mount the said first bead (620) on the said first seat (13′), the said gripping finger (580) being mounted to pivot in such manner that, in alternation, the said pushing means (585) and the said mounting roller (590) can be positioned axially adjacent to the said support (S) and to the said first bead (620), respectively, by pivoting the said gripping finger (580) through 180°.

13) Mounting unit according to any of claims 6 to 12,
characterised in that
the said receiving means (300) is designed to immobilise the said revolution axis of the said wheel (400, 400′) in the direction of gravity.
